(19) United States
(12) Patent Application Publication
(10) Pub. No.: US 2026/0129763 A1
(43) Pub. Date: May 7, 2026

(54) LOW-COST HIGH-SPEED VIA ARCHITECTURE AND IMPLEMENTATION METHOD

(71) Applicant: General Dynamics Mission Systems, Inc., Fairfax, VA (US)

(72) Inventor: Matthew M. Foster, Chandler, AZ (US)

(73) Assignee: General Dynamics Mission Systems, Inc., Fairfax, VA (US)

(21) Appl. No.: 18/934,366

(22) Filed: Nov. 1, 2024

(51) Int. Cl. H05K 3/00; G06F 30/392; G06F 115/12

(52) U.S. Cl. CPC H05K 3/0005; G06F 30/392; G06F 2115/12

(57) ABSTRACT

Signal handling capability of multi-layer printed circuit board is improved by placing anti-pad regions around dangling stub via portions and then enlarging the size of the placed anti-pad regions to reduce capacitive coupling of the via with other structures on the circuit board. Controlled enlargement of via size is based on calculation of electromagnetic coupling simulated from component placement data from the electronic circuit board design-automation tool's data store. Spectral power density calculated by three-dimensional electromagnetic field solver provides a visual indication of the signal handling improvement as the anti-pad size is increased.

### TECHNICAL FIELD

The disclosure relates generally to optimization of via architecture in multi-layer circuit boards and integrated circuits. The disclosure further relates to methods and techniques applicable to printed circuit board design automation software tools and electronic design automation software tools.

### BACKGROUND

This section provides background information related to the present disclosure which is not necessarily prior art.

The design and implementation of high-speed digital circuits challenges both the electronic engineers designing the physical layout of those circuits and also the manufacturing engineers and technicians who implement them. There are several reasons for this:

First, high-speed digital signals critically rely on having sharp rising and falling edges. The sharpness of these edges has a direct bearing on how quickly the change in logical signal state can be detected. When sharply rising and falling edges are assessed using Fourier analysis, one finds that a great number of increasingly higher and higher spectral components are need to be communicated in order to preserve edge sharpness. Thus high-speed digital circuits need to communicate these high frequency spectral components. Thus, in many respects, high-speed digital circuits must have the same signal handling properties as high frequency microwave circuits. In this realm, stray capacitance, signal crosstalk, poorly implemented ground planes, unwanted standing waves, and a host of other demons can interfere with signal integrity.

Second, modern high-speed digital circuit designs are becoming increasing complex. To meet product packaging constraints it is often necessary that the physical circuit be laid out on multiple circuit boards, sandwiched together in a manufactured structure known as a multi-layer board. To communicate signals from layer to layer, and to supply power at proper voltages to these different layers, a conductive structure known as a vertical interconnect access, or via is used. Manufacturing vias is a costly process, involving sandwiching the multiple board together, drilling through-holes at precise locations needed thereby forming the via passageway. The passageway is the then cleaned and chemically plated and/or electroplated, often through several steps, until the inner sidewalls of the via is coated with a conductive material such as copper.

Third, as inevitably happens, technology evolves and the physical circuit components keep getting smaller and smaller. Thus as circuit components get smaller and closer together, vias also need to be made smaller. Drilling smaller holes require more precision and are thus harder and more expensive to manufacture.

Fourth, high-speed digital circuit designs involve an intricate number of component placement and trace layout decisions. As the layout design evolves, traces are routed, component placements are assign and vias are engineered, often with the guidance of layout design automation tools. Design of complex high-speed multilayer circuit boards is an art form, requiring much skill. There will however, be instances where certain vias will have unneeded vestigial sections that exist because of the manufacturing process. Sometimes referred to as via stubs or dangling vias, these vestigial sections may be of no electrical consequence, or they may be acting in the high-frequency domain as tiny transmission line stubs or other unwanted electromagnetically reactive components that may degrade signal integrity. The recognized solution is to remove the vestigial sections by careful drilling. Such drilling is a very expensive process due to the precision required to avoid removing parts of a via that are needed. If a drilling mistake is made, the entire multilayer board may need to be scrapped.

### SUMMARY

The via architectures and the methods and techniques for implemented the disclosed via architectures can best be utilized in conjunction with printed circuit board design software tools and electronic design automation software tools.

Accordingly, disclosed is a method of optimizing signal handling capability of a multi-layer printed circuit board using an electronic computer-aided design automation system of the type which employs a data store identifying the physical relationship among circuit board structures selected from the group consisting of circuit board layers, circuit components, signal traces, electric potential reference planes, vias, pads, anti-pads, substrates, masks and combinations thereof.

The disclosed method comprises the steps of:
1. identifying from the data store a via having a signal handling portion making electrical contact with signal carrying traces on different circuit board layers, and further having a dangling stub portion that extends through additional circuit board layers without electrical contact.
2. For each of the additional circuit board layers:
   a) defining a nonconductive anti-pad structure concentric about the stub portion and extending radially outwardly from the stub portion to a predetermined radial size, thereby establishing a nonconductive spaced relationship between the stub portion and the additional circuit board layer;
   b) recording in the data store information from which the location and radial size of the anti-pad structure may be determined;
   c) computationally increasing the predetermined radial size to an enlarged size based on calculation of capacitive coupling between the stub portion and the additional circuit board layer and recording the enlarged size in the data store; and
3. Using the electronic computer-aided design automation system to generate a standardized electronic printed circuit manufacturing file, based on the enlarged size information stored in the data store, to enable production of a multi-layer printed circuit board having optimized signal handling capability.

### BRIEF DESCRIPTION OF THE DRAWINGS

The drawings described herein are for illustrative purposes only of selected embodiments and not all possible implementations. The particular choice of drawings is not intended to limit the scope of the present disclosure.

FIG. 1 is an example digital pulse train having a predefined clock rate (and corresponding clock period), useful in understanding rise and fall times;

FIG. 2 is a graph depicting the spectral power density of the pulse train of FIG. 1A, useful in understanding clock rate and knee frequency;

FIG. 3 is a cross-sectional view of a multi-layer printed circuit board (PCB) illustrating region where a buried high-speed via couples to ground traces below an identified signal layer;

FIG. 4A is a cross-sectional view of a portion of a multi-layer printed circuit board illustrating the conventional back-drilling approach.

FIG. 4B is a simplified illustration of the circuit board of FIG. 4A illustrating a signal path in a portion of the board not affected by back-drilling.

FIGS. 5A, 5B and 5C (collectively FIG. 5) illustrate how an exemplary circuit board with a proper via signal connection (FIG. 5A) is discarded by drilling too deep (FIG. 5B), or by drilling off center or in an oblique wandering direction (FIG. 5C);

FIG. 6 is a detailed perspective view of an exemplary via, useful in understanding how capacitance of the via is calculated.

FIG. 7 is a graph illustrating D2 hole diameter vs capacitance.

FIG. 8 is a plan view comparing different concentric anti-pad diameters, corresponding to Table I in the detailed description.

FIG. 9 is a cross-sectional view of a multi-layer printed circuit board according to the present disclosure, illustrating how anti-pad clearance is increased on layers below the signal layer to reduce capacitance without back-drilling.

FIG. 10 is an exemplary power spectral density graph, comparing a first case at A in which the via couples capacitively to the ground plane and a second case at B in which capacitive coupling has been reduced utilizing the disclosed increase in anti-pad clearance;

FIG. 11 is a block diagram illustrating how an electronic computer-aided design automation system may be implemented to perform the via enlargement methods disclosed herein;

FIG. 12 is a flowchart diagram useful in understanding the disclosed method of optimizing signal handling capability; and

FIG. 13 is a via equivalent circuit model diagram useful in understanding electromagnetic coupling mechanisms associated with the dangling via stub.

### DETAILED DESCRIPTION

### The Nature of High-Speed Digital Signals

In a printed circuit boards designed to implement direct current circuits and low frequency alternating current circuits, the circuit traces are simply conductive paths to carry the signal from one electronic component to the next. In such circuits the return path flows through a conductive region of the circuit board typically at ground potential. Current-carrying continuity and current carrying capacity of a circuit trace are the key considerations. Layout of circuit traces on the board is largely dictated by placement of components.

However, the situation is much different with digital circuits, particularly when high-speed digital signals are present. Digital signals are driven by a clock that cycles the logic gates through their logic sequence at a predefined clock frequency. Digital signals convey information when the binary signal state changes from high to low or from low to high, in synchronism with the clock. These signal state changes do not happen instantaneously but are dictated by the rise-times and fall-times of the electronic logic gates that generate those signals.

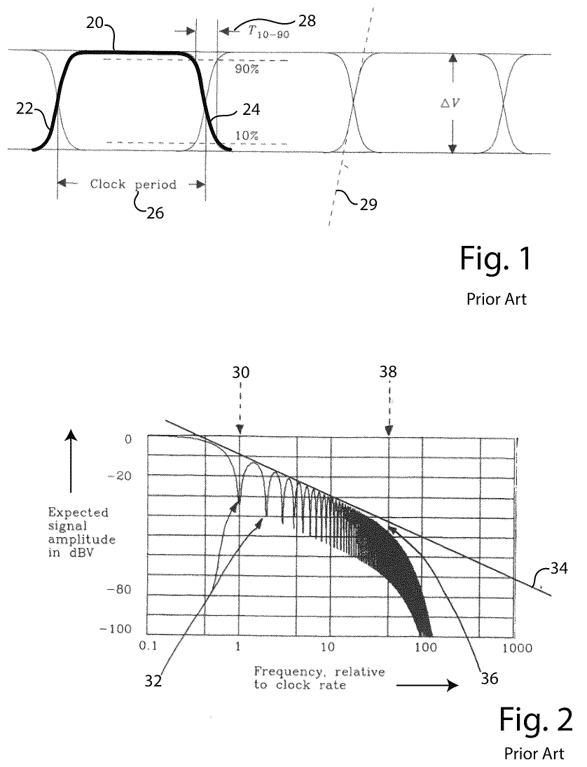

FIG. 1 illustrates how an exemplary digital signal at 20, with leading edge 22 and falling edge 24 fits within the clock period 26. In FIG. 1 the dotted lines labeled 10% and 90%, demarcate the 10-90% range over which the rise or fall times are typically measured. In this case the 10-90% rise or fall time consumes 1/100th of the clock period, as measured by the interval 28. The maximum slope 30 is calculated by dividing the signal amplitude ΔV by the 10-90% interval T₁₀₋₉₀. The faster the rise and fall time(s) the steeper slope 30 becomes. A step edge (90-degree slope) thus represents the theoretical limit.

Fourier analysis shows that fast rise-times and fall-times require high frequency harmonics. More specifically, the steeper the rise or fall slope 29, the greater the number of higher frequency harmonics of the clock frequency are required to define the rising or falling edge. These harmonics can easily extend into the gigahertz frequency range. Thus high-speed digital circuit boards need to have signal traces that can support reliable information transfer at these gigahertz frequencies.

As the frequency goes up, resistance of the circuit board signal traces increases due to the skin effect and reactive effects (capacitance and inductance) also become significant. In essence the high-speed digital circuit behaves more and more like a radio frequency circuit. Thus signal traces and their relationship to conductive regions of adjacent circuit board layers (including ground plane layers and DC supply layers) take on characteristics of RF transmission lines.

FIG. 2 provides a useful illustration of how a high-speed digital circuit behaves in relation to increasing frequency. The vertical axis represents expected (modeled) signal amplitude; the horizontal axis represents increasing frequency (relative to clock rate multiples). In FIG. 2, the clock rate is shown at 30. As seen the signal amplitude dips at a frequency corresponding to the clock rate and at subsequent multiples of the clock rate, as depicted at 32. The signal amplitude curve, known as the spectral power density, initially falls in amplitude with each successive clock rate multiple, as shown by line 34. This fall in amplitude represents a spectral power density roll-off of 20 dB per decade. The roll-off is initially linear, but eventually a curve becomes non-linear, showing greater roll-off as at 36 known as the knee. The point at which the amplitude is down by half of the linear 20 dB per decade roll-off (−6.8 dB) is defined as the knee frequency 38. This knee frequency is a useful metric that is related to signal rise time.

Signal engineers use the spectral power density to assess how effectively a digital circuit can accurately and reliably perform as the data rate (related to clock rate) increases. Most energy in digital signals is concentrated below the knee frequency. Thus the behavior of the circuit at the knee frequency determines how the circuit will process a step edge.

### Via Construction in Multi-Layer Circuit Boards

As noted above, multi-layer printed circuit boards employ vias to communicate signals and power supply currents between layers. On layers where the via must electrically couple to a signal trace electronic computer aided design tool (automation tool) is typically configured to place a conductive pad concentrically around and in electrical contact with the via.

On layers where the via must pass through a conductive layer without making electrical contact (e.g., through a ground plane layer or power supply voltage layer), the automation tool will place an anti-pad concentrically around the via. The anti-pad is an annular region that is etched to remove all copper. The anti-pad establishes a small gap that prevents the via from being shorted to the conductive layer. Typically the anti-pad size will be of a diameter slightly less than the diameter of the conductive pads.

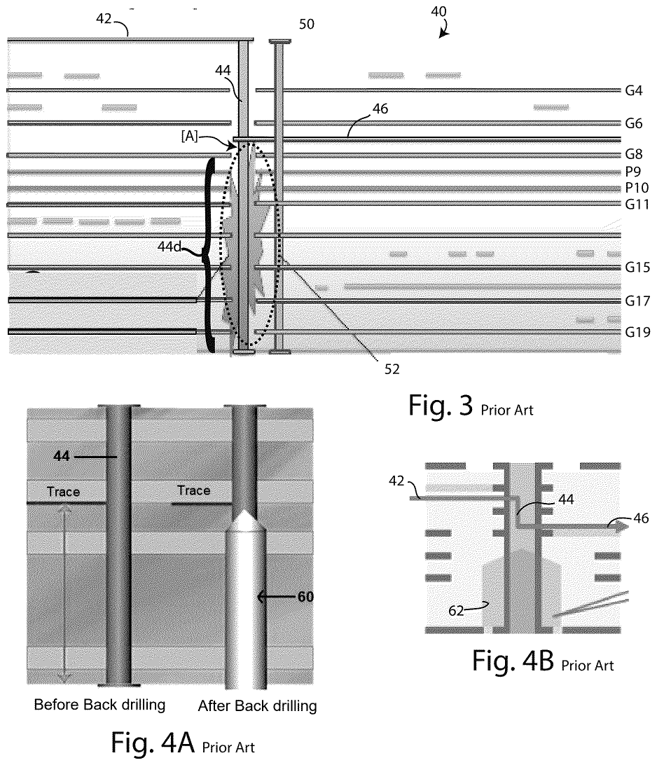

FIG. 3 illustrates an exemplary multi-layer circuit board at 40. Trace 42 on layer one couples through signal via 44 to trace 46 on layer seven. The via stub portion 44d of the through-board signal via 44 is present—due to manufacturing process—but not needed for conveying signals.

This multi-layer circuit board has several ground layers, labeled G4, G6, G8, G11, G15, G17 and G19. In addition, the illustrated multi-layer circuit board has two power supply layers, labeled P9 and P10. The other non-labeled traces are signal traces.

In high-speed digital circuits, the dangling portion 44d of through-board signal via 44 is problematic. The ground and power planes (ground layers G8, G9, G11, G15, G17, G19 and power layers P9, P10) interact electromagnetically with the via portion 44d, creating a via stub, which can cause high frequency reflections on the signal and can degrade signal integrity. These effects are present generally in the region indicated by the dotted oval 52.

From the perspective of the desired signal path (i.e., signal trace 42, through via 44, to signal trace 46) the dangling portion 44d appears as an unwanted inductance coupled to the signal trace at [A], which inductance is then capacitively coupled to the ground and power planes present in region 52 (i.e., ground layers G8, G9, G11, G15, G17, G19 and power layers P9, P10). These combined inductance and capacitances of the dangling via portion 44d result in an unwanted reactance that impairs integrity of the signal traveling on the signal path (trace 42->via 44->trace 46). Reactance effects are frequency dependent. Thus the unwanted reactance will affect different signal edge harmonics differently, thus potentially degrading the signal rise time and fall time. In addition, depending on the dangling via portion's length, it can act as a transmission line stub capable of introducing signal reflections that can also degrade signal integrity.

FIGS. 4A and 4B illustrate the conventional way of dealing with the dangling via portion—use a small drill bit and carefully remove the unwanted dangling portion. This is illustrated in FIG. 4A, where through via 44 is back-drilled using the appropriately sized drill bit 60. FIG. 4B shows that after the drill bit has removed all material in region 62, the signal path defined by trace 42, via 44 and trace 46 are no longer strongly coupled to the ground layers G8, G9, G11, G15, G17, G19 and power layers P9, P10.

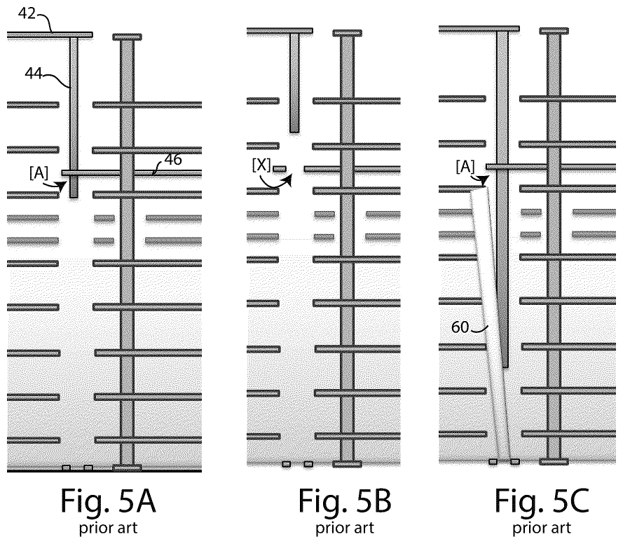

Drilling of via stubs or dangling vias is common practice, and it is prone to expensive errors, as explained in FIGS. 5A, 5B and 5C. FIG. 5A illustrates the result of a proper via drilling, where the signal is properly carried from trace 42, to via 44 and to trace 46. The remainder of the via stub or dangling via at region [A] is quite short (minimal inductance and considerably reduced capacitive coupling to the ground and power layers.

FIG. 5B illustrate improper drilling, where the drill bit went too deep, such that the drill bit tip destroyed the connection at [X]. This board will have to be discarded because the signal path no longer connects trace 42 with via 44 and trace 46.

FIG. 5C illustrates a different example of improper drilling, where the drill bit has wandered off-center, as shown at 60. As seen the via stub or dangling via portion remains coupled at [A] and other traces have been damaged as well. This board will have to be discarded.

### Anti-Pad Size Enlargement

The disclosed solution to the signal degradation problems caused by via stubs or dangling vias employs an entirely different method which eliminates the risk of waste by improper drilling. The method involves selectively modifying or enlarging the anti-pad via sizing in regions where an unwanted via stub or dangling via is present. By modifying the anti-pad size, coupling capacitance is greatly reduced, thereby greatly reducing the deleterious effects upon the high-speed digital signals.

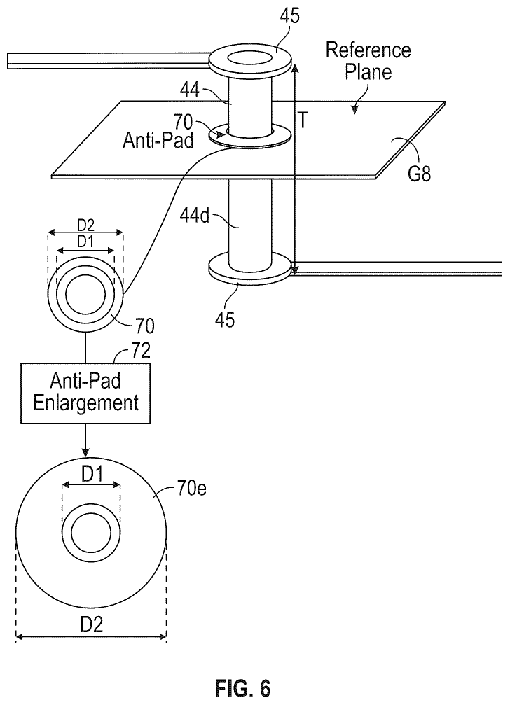

FIG. 6 illustrates the process. FIG. 6 features an exemplary via 44, shown passing through a conductive copper reference plane, such as the ground plane G8 (FIG. 3). So that the via does not come into electrical contact with the reference plane, an annular portion of the copper is etched away as at 70. This etched-away portion is sometimes referred to as an anti-pad because its size typically mirrors that the connection pads 45.

Using suitably modified printed circuit board design automation software tools or electronic design automation software tools—as discussed below—the anti-pad is enlarged (step 72) to present a larger diameter as shown at 70e. The enlarged anti-pad creates a dielectric region providing greater separation between the via body and the conductive copper reference plane. As a consequence of this increased separation, the capacitive coupling between the via and the reference plane is substantially reduced.

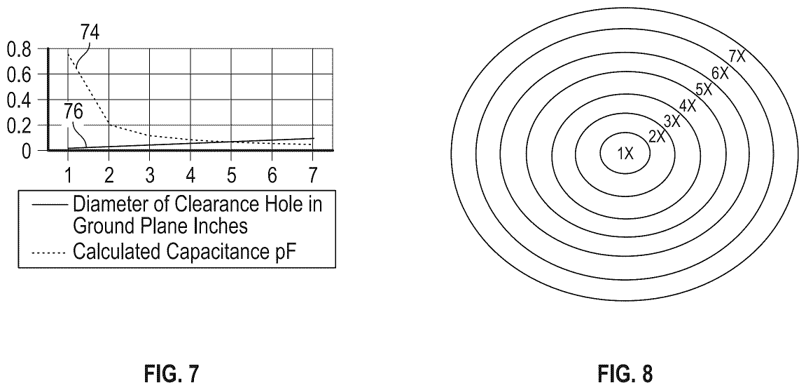

FIG. 7 shows how the capacitance between via and reference plane falls off exponentially, as at 74 while the diameter of the clearance hole in the ground plane is virtually unchanged, as at 66. This relationship can be used to control the level of capacitive coupling between via and reference plane, by controlling the diameter of the anti-pad.

To give a better understanding of this capacitance, refer to Table I, which shows how capacitive coupling between the via and the ground plane changes as a function of the anti-pad diameter. Table I is based on the following equation:

$$C = \frac{1.41 {∈}_{r} {TD}_{1}}{{D}_{2} - {D}_{1}} \qquad Eq . 1$$

Where C is the calculated parasitic capacitance of a via; ∈ᵣ is the relative electric permeability of the circuit board material; D1 is the diameter of the clearance hole in the ground plane(s); D2 is the diameter of the pad surrounding the via; and T is the thickness of the printed circuit board. In Eq. 1 all dimensions are in inches and capacitance is in pF.

TABLE I
Via stub capacitance reduction with increased anti-pad diameter

| | Nominal | 1x | 2x | 3x | 4x | 5x | 6x | 7x |
|---|---|---|---|---|---|---|---|---|
| ∈ᵣ | 4.7 | 4.7 | 4.7 | 4.7 | 4.7 | 4.7 | 4.7 | 4.7 |
| T | 0.063 | 0.063 | 0.063 | 0.063 | 0.063 | 0.063 | 0.063 | 0.063 |
| D₁ | 0.009 | 0.009 | 0.009 | 0.009 | 0.009 | 0.009 | 0.009 | 0.009 |
| D₂ | 0.014 | 0.014 | 0.028 | 0.042 | 0.056 | 0.070 | 0.084 | 0.098 |
| gap | 0.005 | 0.005 | 0.019 | 0.033 | 0.047 | 0.061 | 0.075 | 0.089 |
| C | 0.751502 | 0.751502 | 0.197764 | 0.113864 | 0.079947 | 0.061599 | 0.0501 | 0.042219 |
| % | Reduction | Eff. Cap. | 26% | 15% | 11% | 8% | 7% | 8% |

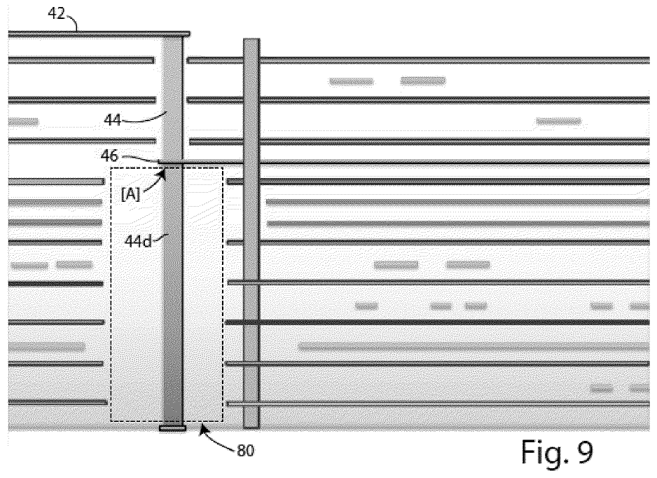

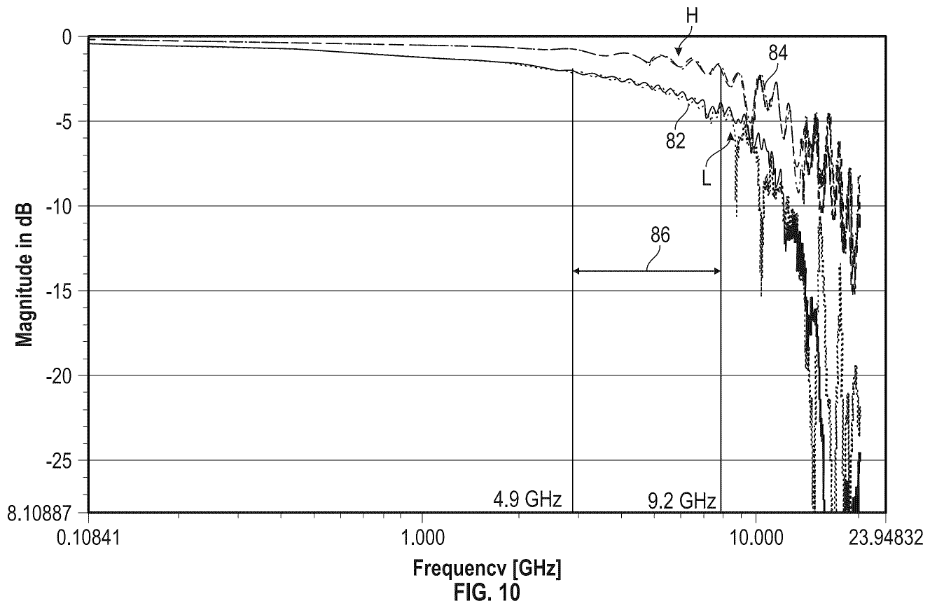

FIG. 9 illustrates the result of the anti-pad enlargement process. The signal trace layer 42 conductively communicates with via 44 and signal trace layer 46, as desired. However, the enlarged anti-pad region 80 isolates the via stub or dangling via portion 46d from the other circuit traces and vias so that there is appreciably less capacitive coupling with these other traces and vias.

As a result, the circuit path following trace layer 42, via 44 and trace layer 46 experiences less capacitive loading at [A] and can thus support higher rise time and fall time signals.

This improvement is illustrated in FIG. 10, which compares the spectral power density curve at L, without anti-pad via enlargement, to the spectral power density curve at H, with an anti-pad via enlargement of 3X diameter (see Table I). Spectral power density curve L thus exemplifies capacitive loading of via portion 44d without anti-pad enlargement, whereas spectral power density curve H exemplifies a much reduced capacitive loading.

One can see from the comparative curves that the spectral power density of curve L crosses through the 3 dB-down point at 82, corresponding to a frequency of 4.9 GHz. In contrast, the spectral power density curve H crosses the 3 dB-down point at 84, corresponding to a frequency of 9.2 GHz—a measurable improvement in bandwidth as denoted at 86.

### Automation Tool Improvement

The anti-pad via enlargement process can be performed manually by the circuit board layout designer. However, the enlargement process is perhaps best performed using suitably modified printed circuit board design automation software tools or suitably modified electronic design automation software tools (both tools hereinafter referred to as automation tools.

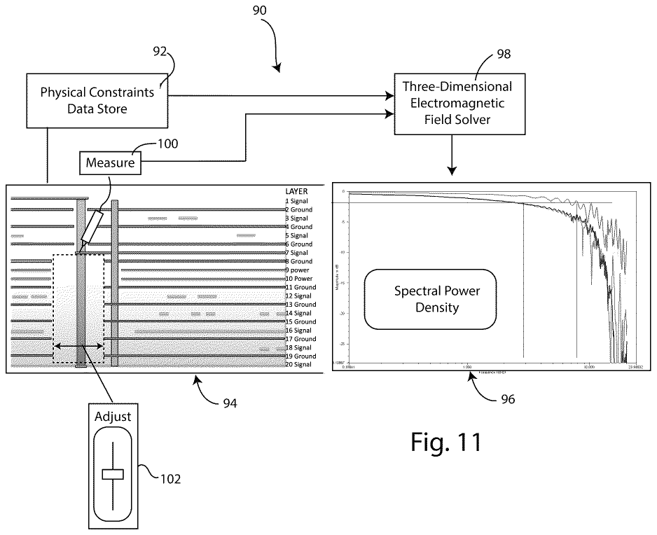

In one embodiment, the automation tool 90 shown in FIG. 11 uses a physical constraints data store 92 to keep a record of every physical component's placement on each layer of the multi-layer circuit being designed, including all component interconnections and via placements. This data store supplies data to the graphical display 94 of the circuit layout.

The automation tool 90 further includes a graphical display 96, which can be presented as a separate window from that of the circuit layout display 94. The automation tool 90 uses the graphical display 96 to present information to the user about different simulated electromagnetic conditions pertaining to the circuit layout being designed. For the present purpose of optimizing anti-pad sizing, display 96 presents a graph of spectral power density.

The spectral power density for the circuit under design is generated by a three-dimensional electromagnetic field solver 98. The field solver is coupled to the physical constraints data store 92 and uses embedded knowledge of Maxwell's equations and other electromagnetic field calculation formulae to simulate what the spectral power density will be at a predetermined measurement point, when the circuit is fabricated as a physical embodiment.

In the illustrated embodiment, the predetermined measurement point is selected by the user by suitable means such as manipulating a virtual measurement pointer 100 to identify the circuit location where the spectral power density calculation is to be performed. This measurement point can be any point specified by the user, such as at the circuit output, or at an intermediate location such as the location where a relevant via is located.

Once the measurement point is established, the user will see the calculated spectral power density at that measurement point. This display can be saved for comparison with a later-calculated spectral power density after anti-pad sizing for a selected via is performed.

To adjust the anti-pad sizing for a particular via, the user identifies the via by placing an adjustable slider tool 102 on the via of choice. Then by adjusting the slider, the user can watch the graphical display 96 and see how changing the anti-pad size may improve the spectral power density.

The adjustable slider works by generating virtual or temporary changes in the physical size and/or dimensions of the anti-pad regions surrounding the via identified by the user. These virtual or temporary changes are used by the field solver 98 to calculate the new spectral power density. The user can accept the virtual or temporary changes if satisfied with the spectral power density improvement; or revert to the original anti-pad sizing.

In a nondestructive editing embodiment, a record of all prior component placements and anti-pad sizing decisions are saved so that the user can readily revert to a previous configuration or quickly make A-B comparisons, perhaps taken from different measurement points 100 within the circuit.

Because the automation tool 90 has knowledge of all physical constraints that define the component placements, preprogrammed safeguard measures are implemented in the slider tool so that anti-pad sizing cannot be changed in size and/or dimensions if doing so will encroach upon the placements of other components or traces.

While the adjustable slider gives the user hands-on control over the anti-pad design, if desired, anti-pad design can be automated using a preprogrammed routine that iteratively adjusts anti-pad sizing for vias that meet predefined conditions-typically where the via has a via stub or dangling via portion that in conventional practice would need to be removed by drilling. If desired the preprogrammed routine may be implemented by parallel processing of several anti-pad sizing decisions concurrently.

The automated implementation is thus able to find the optimal anti-pad sizing for a plurality of vias to achieve the highest possible spectral power density.

### Flowchart

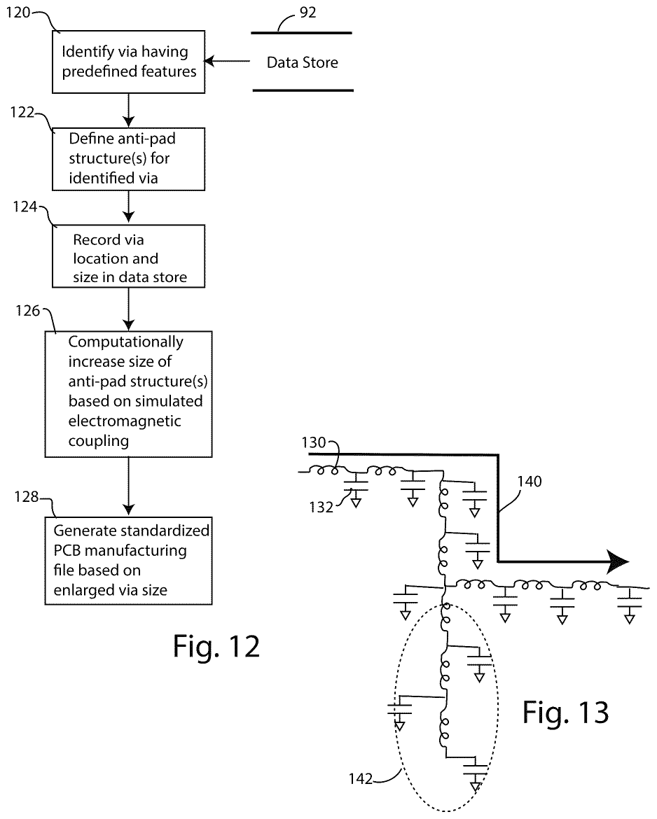

FIG. 12 illustrates the process by which the disclosed method and the automation tool 90 (FIG. 11) may be performed. The steps shown in FIG. 12 operate on information stored in the data store 92 of the automation tool 90.

At step 120, a via is identified among the records in data store 92 as a candidate for anti-pad size enlargement. The via is identified by virtue of having a dangling stub portion extending through additional circuit board layers as discussed above.

For each additional circuit board layer that the stub portion extends through, the automation tool is programmed to define an anti-pad structure, as at step 122, which structure is then stored at step 124 in the data store 92.

The anti-pad structure so generated is of a predetermined radial size (i.e., a predetermined diameter) and extends radially outwardly from the stub portion, thereby establishing a nonconductive spaced relationship between the stub portion and the additional circuit board layer.

In step 126, the automation tool is programmed to computationally increase the predetermined radial size to an enlarged size based on calculation of electromagnetic coupling between the stub portion and the additional circuit board layer(s). This increased (enlarged) radial size is stored in data store 92.

The electromagnetic coupling will better be understood with reference to the via equivalent circuit model shown in FIG. 13. The signal-carrying circuit traces and vias can be modeled as a series of lumped inductors 130 and shunt capacitors 132. In FIG. 13, the signal flow follows path 140. The dangling stub portion is shown at 142. The lumped inductances model magnetic components of the electromagnetic field; the capacitive components model electric components of the electromagnetic field.

Both the magnetic and electric components of the electromagnetic field represent primarily near-field coupling effects that fall off exponentially in intensity over a short distance. In the dangling stub portion 142 the capacitive effect is dominant in high-speed digital circuits. Thus the goal of enlarging the via size associated with the stub portion of the via is to reduce the capacitive coupling with other components on the circuit board layers.

The processing step 126 of computationally increasing the anti-pad size is guided by calculated knowledge of the electromagnetic coupling of the anti-pads along the stub via with other components on the circuit board layers. This computational step is performed by a processor of the automation tool 90, such as by the three-dimensional electromagnetic field solver 98 (FIG. 11). The solver computes the net effect of the capacitive coupling associated with the stub portion 142 (FIG. 13). If desired the solver can also calculate a spectral power density of a simulated signal flowing on a signal-carrying trace, such as the signal flow path 140 (FIG. 13).

The anti-pad enlargement process may also be bounded or limited to a maximum anti-pad size to prevent the anti-pad from encroaching on other circuit board structures, as determined by information about the location of these other structures in the data store.

Although the anti-pad layout and enlargement process can be fully automated by the processor of the automation tool, if desired, a user interface may be provided, as illustrated in FIG. 11, so that the human operator can assist in selecting the via candidate for anti-pad enlargement, or in selecting the measurement point on the multi-layer circuit board where the relevant electromagnetic coupling occurs, or in selecting the portion where the signal handling capability of the multi-layer circuit is to be optimized. Thus the human operator can observe the spectral power density on graphical display 96 (FIG. 11) and assist in manipulating the slider tool 102 (FIG. 11) to achieve the desired optimal signal handling capability.

After the anti-pad size(s) have been enlarged for optimum signal handling capability, the automation tool, at step 128, generates a standardized electronic printed circuit board manufacturing file, based on the enlarged anti-pad sizes stored in data store 92, to enable production of a multi-layer printed circuit board having optimized signal handling capability.

While the exemplary embodiment has been illustrated in connection with a multi-layer circuit board design, the principles disclosed can be applied to integrated circuit design. Thus while at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. Various changes may be made in the function and arrangement of elements described in an exemplary embodiment

1. A method of optimizing signal handling capability of a multi-layer printed circuit board using an electronic computer-aided design automation system of the type which employs a data store identifying the physical relationship among circuit board structures selected from the group consisting of circuit board layers, circuit components, signal traces, electric potential reference planes, vias, pads, anti-pads, substrates, masks and combinations thereof, comprising the steps of:
identifying from the data store a via having a signal handling portion making electrical contact with signal carrying traces on different circuit board layers, and further having a dangling stub portion that extends through additional circuit board layers without electrical contact;
for each of the additional circuit board layers:
a) defining a nonconductive anti-pad structure concentric about the stub portion and extending radially outwardly from the stub portion to a predetermined radial size, thereby establishing a nonconductive spaced relationship between the stub portion and the additional circuit board layer;
b) recording in the data store information from which the location and radial size of the anti-pad structure may be determined;
c) computationally increasing the predetermined radial size to an enlarged size based on calculation of electromagnetic coupling between the stub portion and the additional circuit board layer and recording the enlarged size in the data store; and
using the electronic computer-aided design automation system to generate a standardized electronic printed circuit manufacturing file, based on the enlarged size information stored in the data store, to enable production of a multi-layer printed circuit board having optimized signal handling capability.

2. The method of claim 1 further comprising defining a group of anti-pad structures recorded in the data store and computationally increasing each of the group to the same enlarged size.

3. The method of claim 1 wherein the electronic computer-aided design automation system includes a processor and wherein the calculation of capacitive coupling is performed using the processor.

4. The method of claim 1 wherein the electronic computer-aided design automation system includes an electromagnetic field solver and wherein the calculation of capacitive coupling is performed using the electromagnetic field solver.

5. The method of claim 1 wherein the electronic computer-aided design automation system includes an electromagnetic field solver; and further comprises using the electromagnetic field solver to calculate a spectral power density indicative of the signal handling capability of a multi-layer printed circuit board.

6. The method of claim 5 further comprising iteratively adjusting the enlarged size to optimize the signal handling capability of a multi-layer printed circuit board.

7. The method of claim 1 wherein the step of computationally increasing the predetermined radial size to an enlarged size is limited to a maximum size to prevent the anti-pad from encroaching on other circuit board structures as determined by information in the data store.

8. The method of claim 1 wherein the step of computationally increasing the predetermined radial size to an enlarged size is limited to a maximum size to prevent the anti-pad from violating predetermined circuit board structure layout rules stored in the data store.

9. An automation tool for optimizing signal handling capability of a multi-layer printed circuit board, the automation tool being of the type having a processor with associated memory and a user-interface display coupled to the processor, comprising:
a data store coupled to the processor and having predefined data structure to store the physical relationship among circuit board structures selected from the group consisting of circuit board layers, circuit components, signal traces, electric potential reference planes, vias, pads, anti-pads, substrates, masks and combinations thereof;
a measurement pointer tool implemented by program code stored in the associated memory and running on the processor, the measurement pointer tool being operable to interface with the data store and identify a specific via associated with a via under test;
an electromagnetic field solver implemented by program code stored in the associated memory and running on the processor, the solver being operable to locate a predetermined test location of the circuit board by interfacing with the data store and being further operable to calculate an electromagnetic property at the test location as a function of the electromagnetic properties of the via under test;
an anti-pad size adjustment tool implemented by program code stored in the associated memory and running on the processor, the anti-pad size adjustment tool being operable to increase the size of at least one anti-pad associated with the via under test based on the electromagnetic property calculated by the solver.

10. The automation tool of claim 9 wherein the anti-pad size adjustment tool is further operable to increase the size of the at least one anti-pad until a size constraint based on physical relationship information stored in the data store is reached.

11. The automation tool of claim 9 further comprising a display generator implemented by program code stored in the associated memory and running on the processor, the display generator providing an indication to a user regarding the calculated electromagnetic property at the test location;

12. The automation tool of claim 11 wherein the anti-pad size adjustment tool includes a user input allowing the user to control the size of the at least one anti-pad in accordance with the indication provided by the display generator.

13. The automation tool of claim 11 wherein the display generator provides a spectral power density display.

14. The automation tool of claim 9 wherein the anti-pad size adjustment tool automatically increases the size of at least one anti-pad associated with the via under test based on the electromagnetic property calculated by the solver.

15. The automation tool of claim 9 wherein the electromagnetic property is capacitive coupling between the via under test and components represented in the data store.

16. The automation tool of claim 9 wherein the electromagnetic property is spectral power density of a calculated signal present at the test location.
